(19) United States
(12) Patent Application Publication
(10) Pub. No.: US 2017/0124799 A1
(43) Pub. Date: May 4, 2017

(54) GAMING DEVICES WITH PROGRESSING MULTIPLIERS

(71) Applicant: KING SHOW GAMES, INC., Minnetonka, MN (US)

(72) Inventors: Bradley BERMAN, Minnetonka, MN (US); Jacob LAMB, Maple Grove, MN (US)

(21) Appl. No.: 15/343,203

(22) Filed: Nov. 3, 2016

Related U.S. Application Data
(60) Provisional application No. 62/250,500, filed on Nov. 3, 2015.

(51) Int. Cl. G07F 17/32; G07F 17/34

(52) U.S. Cl. CPC G07F 17/3213; G07F 17/3244; G07F 17/34

(57) ABSTRACT

Embodiments of the present invention set forth systems, apparatuses and methods for utilizing progressing multipliers in gaming devices. Accordingly, a gaming device can be configured to increment a game multiplier for a next gaming event based on incrementing conditions received during a current gaming event. The game multiplier is also decremented according to decrementing conditions resulting in a game multiplier that can progress upwards or downwards between gaming events played on the gaming device.

### RELATED APPLICATIONS

This application claims the benefit of Provisional Patent Application No. 62/250,500, filed on Nov. 3, 2015, to which priority is claimed pursuant to 35 U.S.C. §119(e) and which is incorporated herein by reference in its entirety.

### FIELD OF THE INVENTION

This disclosure relates generally to games, and more particularly to systems, apparatuses and methods for implementing progressing multipliers in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate the implementation of progression multipliers in gaming devices.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention

FIGS. 3A, 3B, 3C, 3D, 3E, 3F, 3G, and 3H are diagrams of a gaming display showing a series of gaming events according to embodiments of the invention.

FIG. 4 is a diagram of a gaming display showing a video poker gaming event according to embodiments of the invention.

FIGS. 5A, 5B, and 5C are diagrams of a gaming display showing another series of gaming events according to embodiments of the invention.

FIGS. 6A, 6B, and 6C are diagrams of a gaming display showing another series of gaming events according to embodiments of the invention.

FIGS. 7A, 7B, 7C, 7D, 7E, 7F, 7G, and 7H are diagrams of a gaming display showing a series of gaming events according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing winning result opportunities in gaming activities by implementing progressing multipliers. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that implement progressing multipliers during game play of the gaming devices. According to some embodiments, a gaming device can be configured to increment a game multiplier for a next gaming event based on incrementing conditions received during a current gaming event. The game multiplier may also be decremented according to decrementing conditions resulting in a game multiplier that can progress upwards or downwards between gaming events played on the gaming device.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, or other games of chance. Some of these other types of embodiments will be discussed below as variations to the examples illustrated. However, many other types of games can implement similar techniques and fall within the scope of this inventive concept.

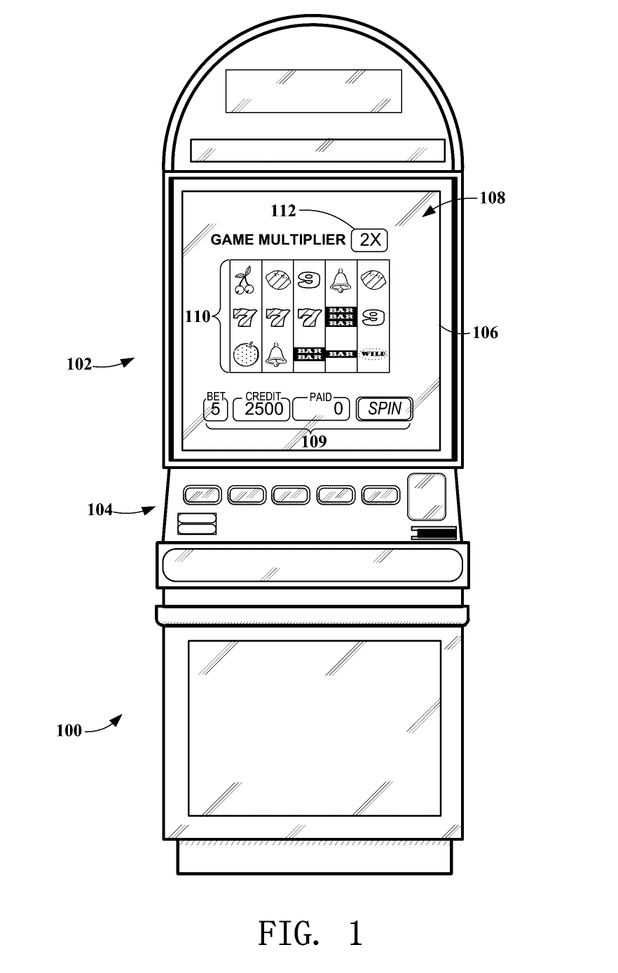

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, a secondary display portion 112 showing a game multiplier, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity.

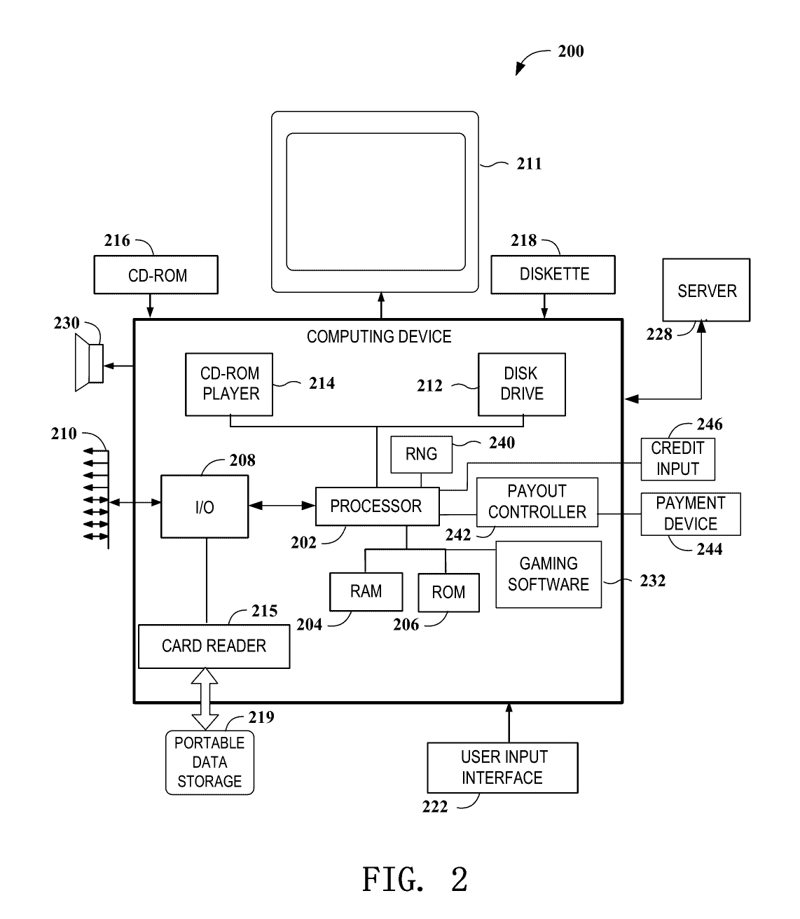

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some the example embodiments illustrated herein, the primary gaming portion 108 may display a grid (or equivalent arrangement) of game elements 110 or game element positions (also referred to as “reel stop positions” herein). As illustrated in the embodiment shown in FIG. 1, the grid includes three rows and five columns of game elements 110, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play. In embodiments featuring video poker or other games of chance, the primary gaming portion may include card positions for the dealing of a poker hand or other types of set-ups for game elements 110. The secondary display 112 may show gaming information associated with the game events played on the gaming device 100. In the embodiment shown in FIG. 1, the secondary display 112 includes the display of a game multiplier. In other embodiments, the secondary display 112 may include other game information.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As described above, embodiments of the present concept include implementing progressing multipliers in gaming devices. These progressing multipliers may be configured to progress upwards or downwards between gaming events played on the gaming device. In some embodiments, a gaming device can be configured to increment a game multiplier for a next gaming event based on incrementing conditions received during a current gaming event. The game multiplier may also be decremented according to decrementing conditions. The incrementing condition may be satisfied when a predefined symbol appears on a game grid of the gaming device as part of a game outcome. In other embodiments, the incrementing condition may be receiving a subsymbol on the game grid of the gaming device as part of a game outcome. The incrementing condition may also be a random mystery trigger, a multiplier initialization condition, receipt of a side wager, a predefined symbol combination appearing in a game outcome, reaching a minimum multiplier value, or other conditions relating to game play of the gaming device. The decrementing condition may be finishing the play of a gaming event, receipt of a predefined symbol or subsymbol that appears on the game grid on the gaming device, reaching a maximum multiplier value, a random mystery trigger, reaching a predefined number of games with a multiplier value, or other conditions relating to game play of the gaming device.

In other embodiments, there may only by an incrementing condition or a decrementing condition, but not both. For example, a multiplier may be initialized and increment upwards to an end condition, such as reaching a maximum multiplier value, reaching a predefined number of games with the multiplier, using the multiplier in a winning combination associated with an award, not using the multiplier in a game outcome, receiving a predetermined symbol in a game outcome, or otherwise having a multiplier end-condition occur. Alternatively in another example, a multiplier may be initialized with a value and then decremented downwards to an end condition, such as reaching a 1× or 0× state when decrementing the multiplier, reaching another minimum value for the multiplier, reaching a predefined number of games with the multiplier, using the multiplier in a winning combination associated with an award, not using the multiplier in a game outcome, receiving a predetermined symbol in a game outcome, or otherwise having a multiplier end-condition occur.

The progressing multiplier determined from a game outcome may be used in a subsequent gaming event. In some embodiments, this subsequent gaming event is the next gaming event that a wager is placed on. In other embodiments, the subsequent gaming event may be the next game or stage in a free spins bonus event where another wager is not required for the subsequent gaming event. In some embodiments, the multiplier may progress upward or downward continuously over a series of gaming events. In other embodiments, the multiplier may only apply to the next gaming event. In other embodiments, the multiplier may be initialized to a particular value and decremented over a number of following gaming events, where the number of following gaming events may be predetermined or based on the receipt of decrementing symbols (or other decrementing conditions) during game play of the following gaming events.

In one embodiment, there is an incrementing symbol (or overlay) X that spins with the reels. If one incrementing symbol X appears on the reels or game grid as part of a game outcome, nothing happens. If two or more incrementing symbols X appear on the game grid as part of a game outcome for a given spin, the number of incrementing symbols X is added to a multiplier “pile.” This multiplier pile applies to the next spin, and decrements by one on each subsequent spin until it reaches 1.

For example, in a 5×3 game grid, suppose the following game outcome is received:

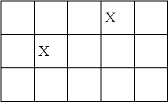

This would generate a “2×” multiplier for the next spin. The “2×” multiplier would decrement after the spin leaving no multiplier for any subsequent spins.

Alternatively, suppose the following game outcome is received:

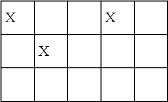

Here, the player would receive a “3×” multiplier on the next spin, and then a “2×” multiplier on the following spin. If the player received an additional multiplier from landing more incrementing symbols X while a current multiplier is active, the new multiplier amount would be added to the pile. This feature has the potential to create large multiplier values in a short period of time.

In other embodiments, the progressing multiplier could be applied in an opposite direction, where a maximum or top multiplier is set and the game multiplier increments until the maximum multiplier is reached. Here, any multipliers added during game play may increase the maximum multiplier. Once the maximum multiplier is reached, the next spin may be returned to a “1×” multiplier.

In some embodiments, receiving one or more incrementing symbols may increment a game multiplier and receiving a secondary symbol may cause the game multiplier to be used with the current game outcome or used with the next game outcome. For example, receiving a “1×” incrementing symbol may increment the game multiplier by one each time it is received, while receiving a “2×” secondary symbol may cause the game multiplier to be incremented by two, but used with the next game outcome played.

In another embodiment, the game starts with a multiplier of “1×,” which is designated as the current multiplier (“M”). On any given spin, the player will be awarded 0, 1, 2 or 3 incrementing symbol overlays. These incrementing symbol overlays may only appear on reels 1, 3, and 5, or may potentially appear on any game reel. The number of overlays on a spin will be designated as “OV”. After each spin, the next spin multiplier equal to:

NM=(M−1)+OV

In other words, for the next spin multiplier is determined by taking the current spin multiplier, subtracting 1 and then adding the overlays from the current spin. In some embodiments, if (M−1) is less than 1, the result of (M−1) is set equal to 1.

For example, if the current multiplier is “1×,” and two incrementing symbol overlays are received on the current spin, the next spin will have a “3×” multiplier. This result may be determined by setting the result of (M−1) equal to one (because M is currently 1, and 1-1 otherwise results in 0), and then adding 2 from the two received incrementing symbol overlays to get “3×.” In other embodiments where the only condition is the prevention of zero or negative multiplier values from the above equation (i.e., NM=the greater of ((M−1)+OV) or (1×)), the multiplier for the next spin would be “2×” because (M−1) would be zero and the 2 overlays would only bring the next multiplier to “2×.”

In this embodiment, the multiplier is capped at “12×.” This would result in an incrementing multiplier overlay probability table as follows:

| Prob of Getting Sub | | | |
|---|---|---|---|
| Symbols | | Cap | Mult |
| 0 | 0.63 | 12 | 1.974451 |
| 1 | 0.22 | | |
| 2 | 0.11 | | |
| 3 | 0.04 | | |

If, for example, the multiplier feature costs about “2×” when determining the game math, a side wager necessary to initiate the feature may be “2×” of a normal game wager. Here, if the multiplier feature was applied to a 30 line game, a wager of 60 credits would be required to play all 30 lines with the multiplier feature. Below is a sample set of spins, overlays, and multipliers:

| | Current Spin | Current Spin | |
|---|---|---|---|
| Spin # | Multiplier | Overlays | Next Spin Multiplier |
| 1 | 1 | 2 | 3 |
| 2 | 3 | 0 | 2 |
| 3 | 2 | 0 | 1 |

When incrementing or decrementing the multipliers, the amount that the multiplier is incremented or decremented may not be linear. For example, a multiplier group of 1×, 2×, 3×, 4×, 5×, 10×, 15×, 20×, and 25× may be used. Here, for example, if the multiplier is at 4× and two incrementing subsymbol overlays are received, the nest-game multiplier may be 10×.

The multipliers may be applicable to the entire gaming event where any award condition resulting from a game outcome is multiplied by the game multiplier, or the multiplier may be associated with specific portions of the game—such as one or more of line pays, scatter pays, bonus pays, wild symbol pays, mystery pays, etc. In other embodiments, a plurality of game multipliers may be used. Each of these multipliers may be used for a different part of the game. For example, individual multipliers may be associated with individual rows of a game grid, individual columns of a game grid, individual paylines covering the game grid, individual scatter pays, individual progressive meters, bonus events, etc. In a multi-hand video poker embodiment, multiple game multipliers may be used such that each hand of the multi-hand poker game has its own multiplier.

The multipliers may be shown in a single game multiplier meter, or the display may show both a current-game multiplier and a next-game multiplier. If the display shows only a game multiplier, the multiplier associated with the current game may be shown throughout the game. The multiplier display may then be modified after the game is over to show a next game multiplier in the multiplier display area or meter. If both a current-game multiplier and next-game multiplier are shown, the current game multiplier may be applicable to a current game while showing the player what the multiplier will be for the next game. In embodiments, that have multiple game multipliers, multiple current-game multipliers and next-game multipliers may be shown. Here, the next-game multiplier values may be transferred over to the current-game multiplier meters when the next game or gaming event is initiated. Additionally, the next game multiplier for a new game may start out the same as the current game multiplier and then be modified based on the play or outcome of the current gaming event. Below are descriptions of several embodiments. However, these embodiments may have features added or removed to create variations and other embodiments using the features described above.

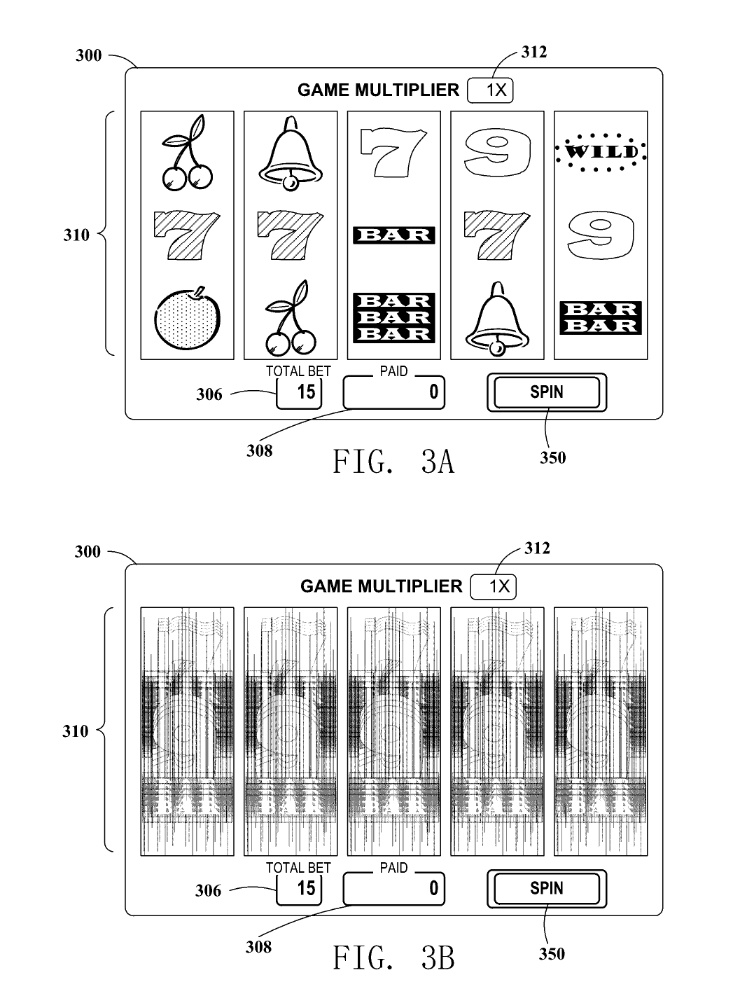

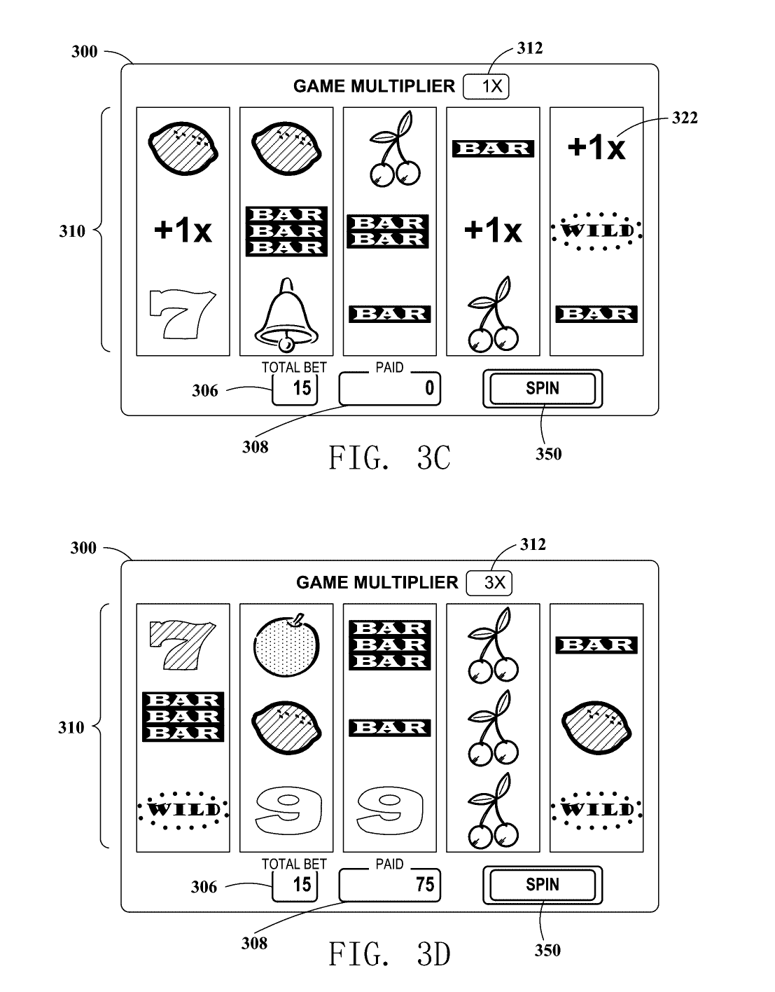

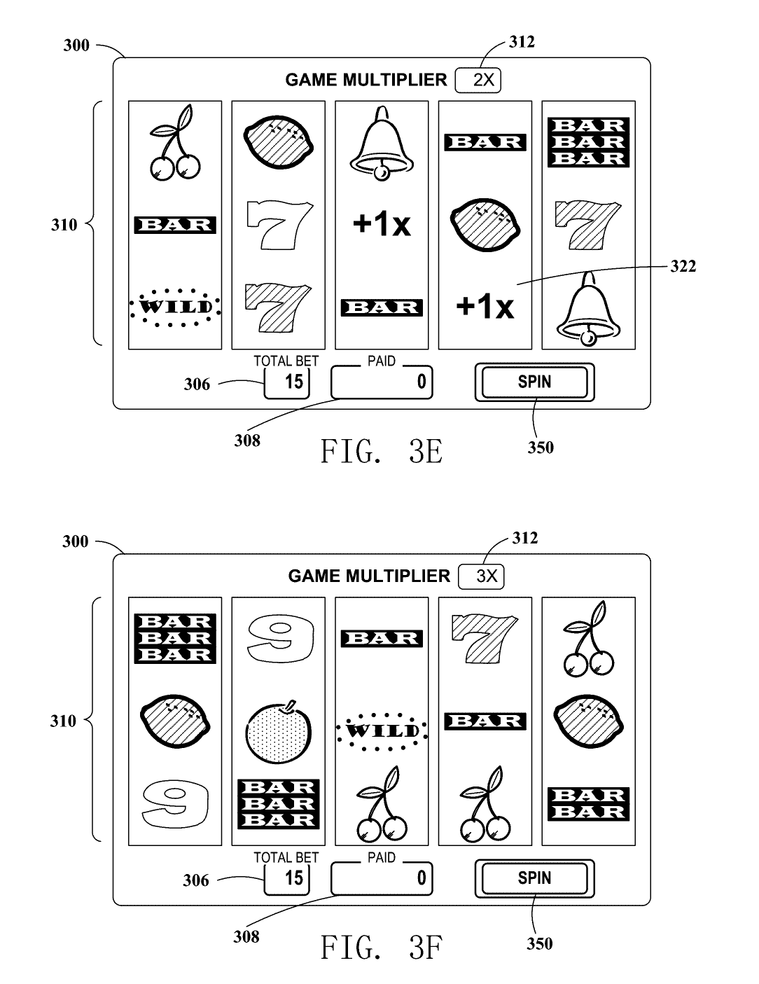

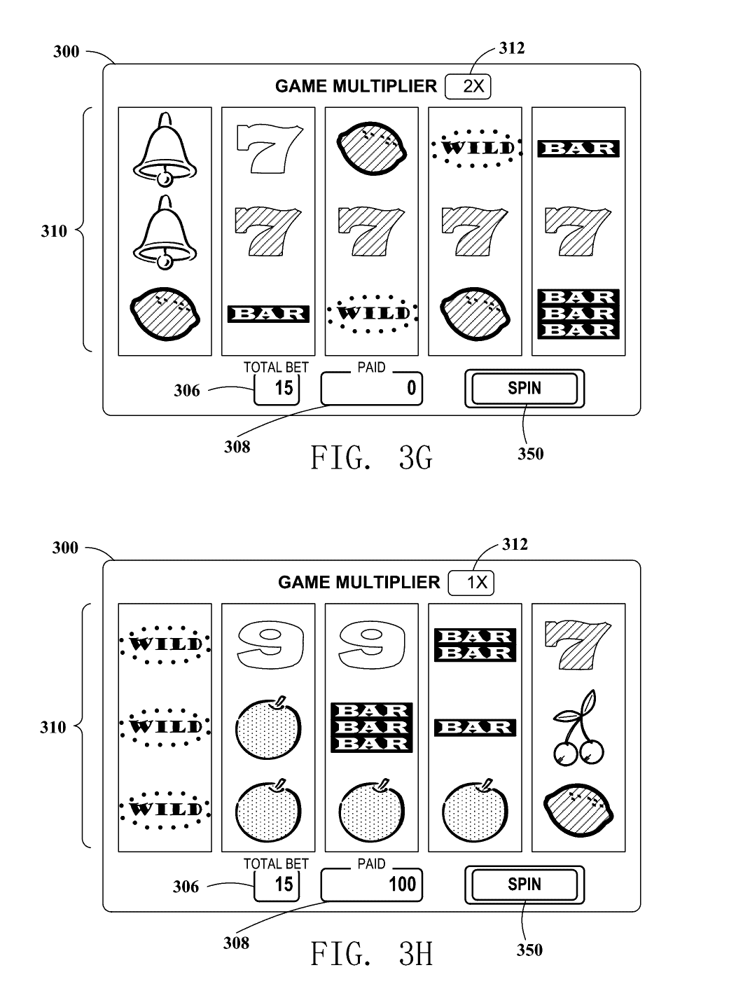

FIGS. 3A-3H are diagrams of a gaming display showing a series of gaming events according to embodiments of the invention. Referring to FIGS. 3A-3H, a gaming display 300 includes a player interface portion having a Total Bet Meter 306, a Paid Meter 308, and a SPIN button 350. The gaming display 300 also includes a game grid 310 showing portions of five game reels each having multiple game symbols, and a game multiplier meter 312. Here the game multiplier meter 312 shows a game multiplier associated with a game outcome. As shown in FIG. 3A, this game multiplier meter begins with a value of “1×.” The game reels spin in the game grid 310 is FIG. 3B, and the game outcome for the first gaming event is shown in FIG. 3C. Here, three incrementing symbols 322 are received in the game outcome. Hence, the next gaming event will have a multiplier “3×,” which is shown in the game multiplier meter 312 in FIG. 3D. In other embodiments, the game multiplier meter 312 or another meter may show the multiplier to be applied to the next gaming event prior to the gaming event being wagered on. In FIG. 3E, the multiplier value is decremented by one for the next gaming event to “2×” since no additional incrementing symbols were received in the prior game outcome. As shown in FIG. 3E, two additional incrementing symbols 322 are received. This means that the multiplier value for the next gaming event will be “3×” as is shown in FIG. 3F. In FIGS. 3G and 3H, no additional incrementing symbols are received, and the multiplier value is decremented by one for each gaming event wagered on.

In FIGS. 3A-3H, the incrementing condition is the receipt of incrementing symbols 322 in the game grid 310 as part of the game outcome. In some embodiments, these symbols may be wild symbols that can replace some or all of the other possible symbol outcomes in the game element position it lands. In other embodiments, the incrementing symbol may be removed from the game grid, and the symbols may cascade down to fill the game grid in the reel or reels that have incrementing symbols removed. In yet other embodiments, the reels with the incrementing symbols may be respun to show a new game outcome. In other embodiments, the incrementing symbols may be overlays that cover other symbols on the game grid. The display may alternate between the symbols to show both the incrementing symbol and the underlying symbol, or may remove the overlay and count it toward a next-game multiplier thereby showing the underlying symbol.

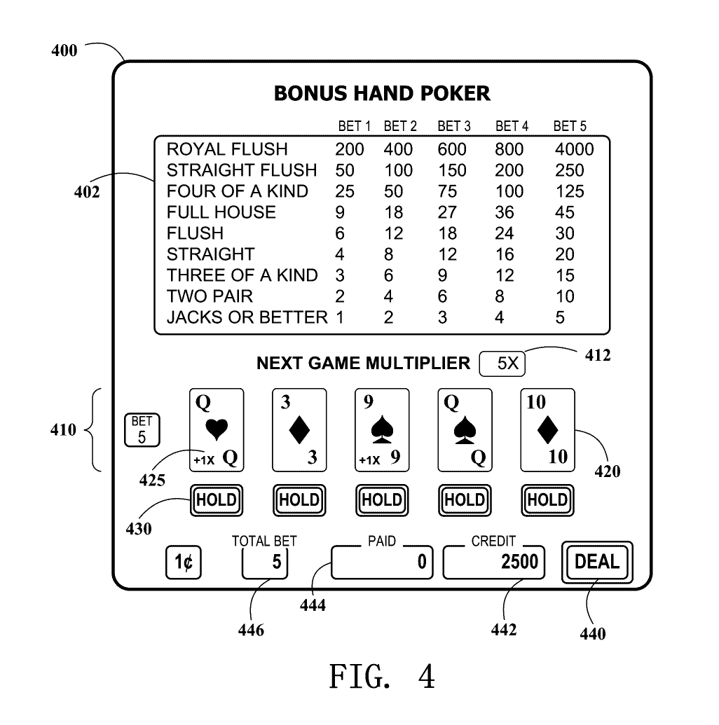

FIGS. 4, 5A-5C, and 6A-6C are diagrams of a gaming display showing video poker gaming events according to embodiments of the invention. Referring to FIG. 4, a game display 400 includes a paytable 402, a grid of card position 410 forming a poker hand when cards 420 are dealt to the card positions, and a player interface portion having a one or more interactive buttons (such as hold buttons 430 and a deal/draw button 440), a credit meter 442, and paid meter 444, and a total bet meter 446. In addition the display includes a next game multiplier meter 412. Here, when cards 420 are dealt to the card positions 410, they may include a subsymbol 425 that is used to generate a next game multiplier 412. As shown in FIG. 4 a multiplier for the current game may be 3× and the addition of the two cards 420 with subsymbols 425 may increment the next game meter to 5×, which will be the multiplier used for the next poker hand. In draw poker games, some embodiments allow the subsymbols to stay with a symbol position 410 when a card is discarded so that the general poker strategy is not affected by deciding whether to hold a card with a subsymbol. In other embodiments, once a card with a subsymbol is received, that sub symbol is withdrawn from the card and used to increment a next-game multiplier. In those embodiments a card received on the draw may have an incrementing subsymbol and a replacement card for that card might have another subsymbol associated with it, giving the player at least two incrementing subsymbols. Thus, the incrementing sub-symbols are used to trigger progressing multipliers.

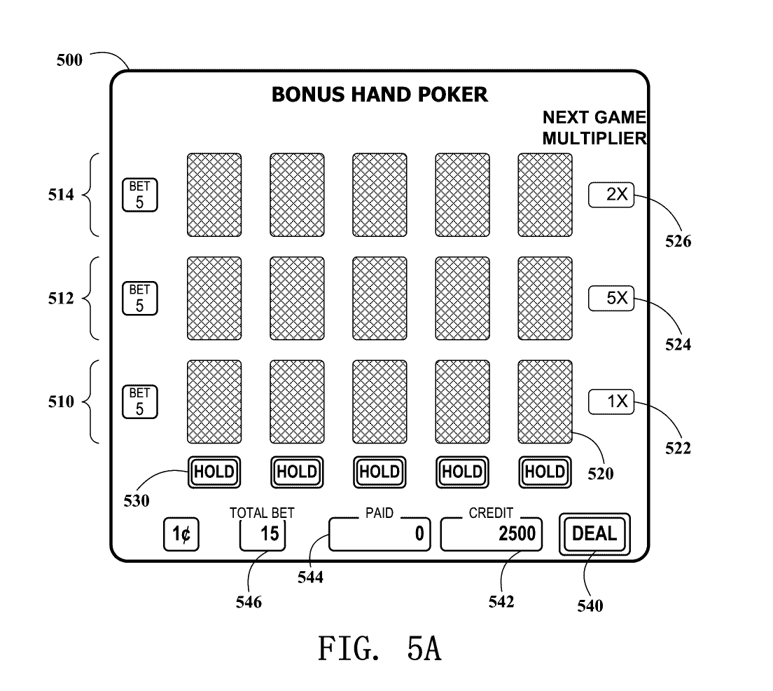

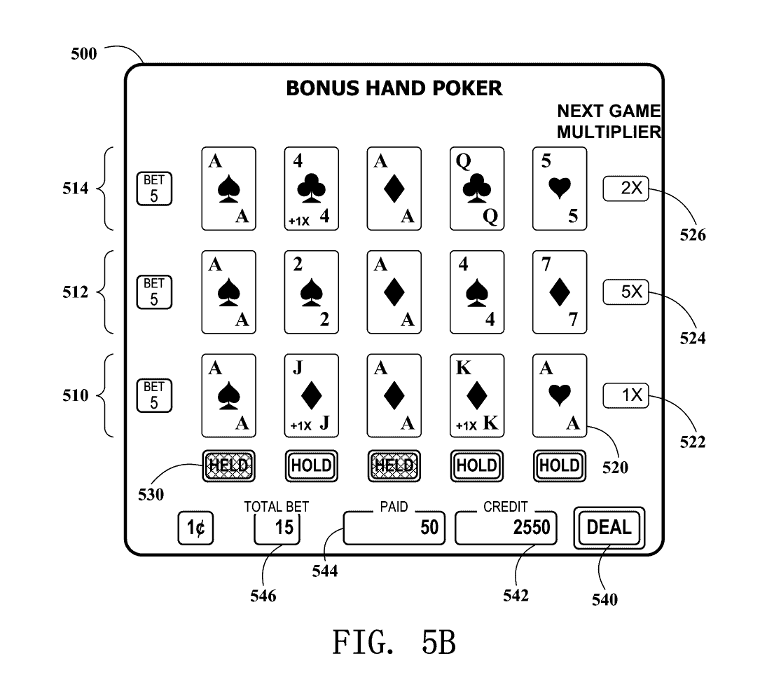

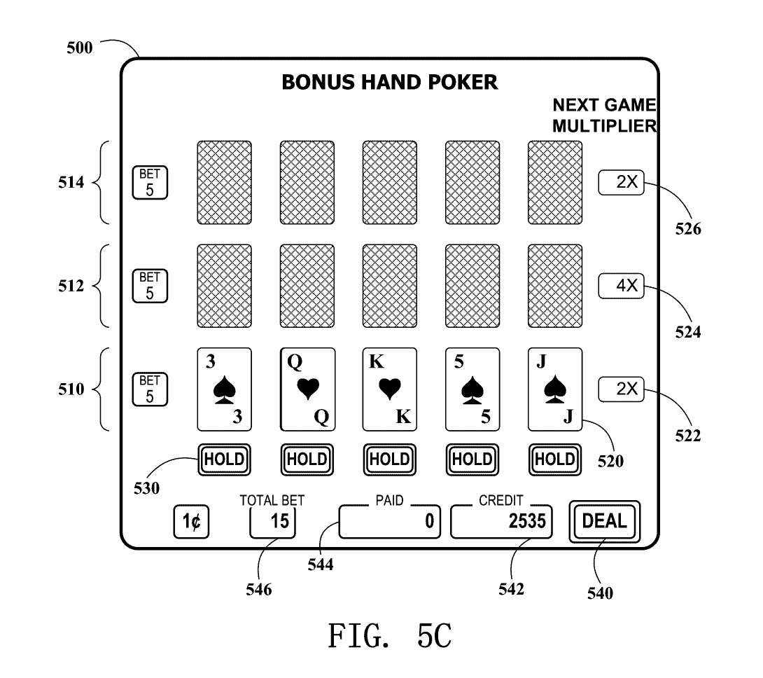

Referring to FIGS. 5A-5C, a game display 500 includes a first grid of card position 510 forming a first poker hand when cards 520 are dealt to the card positions, a second grid of card position 512 forming a first poker hand when cards 520 are dealt to the card positions, a third grid of card position 514 forming a first poker hand when cards 520 are dealt to the card positions, and a player interface portion having a one or more interactive buttons (such as hold buttons 530 and a deal/draw button 540), a credit meter 542, and paid meter 544, and a total bet meter 546. In addition the display includes a first next-game multiplier meter 522, a second next-game multiplier meter 524, and a third next-game multiplier meter respectively associated with the first, second, and third grids of card positions 510, 512, 514.

Referring to FIG. 5A a new game is wagered on and the next-game multipliers 522, 524, and 526 are set for this new game. In FIG. 5B, the cards in the first hand 510 are dealt, and the Ace of Spades and Ace of Diamonds are held, which holds the same card in the second poker hand 512 and third poker hand 514. The remaining cards in the first poker hand are discarded on the draw and new cards are dealt to fill in the remaining card positions in the first poker hand 510, second poker hand 512, and third poker hand 514. Here, the next game multipliers 522, 524, and 526 are then applied to the awards associated with the respective poker hands 510, 512, 514. The paid meter 544 reflects that the pair of aces award of 5 credits in the third poker hand is doubled by the third next-game multiplier of 2×, that the pair of aces award of 5 credits in the second poker hand is multiplied by the second next-game multiplier of 5×, and the three-of-a-kind of aces award of 15 credits in the first poker hand (the first next-game multiplier does not affect the award since it is 1×) for a total win of 50 credits.

Here, the third poker hand 514 has a “+1×” incrementing subsymbol, and the first poker hand 510 has two “+1×” incrementing subsymbols. Hence, as shown in FIG. 5C, the next-game multipliers are modified for the next game by decrementing each amount in the next-game multipliers by one and incrementing each next-game multipliers by the values of the associated incrementing subsymbols received in the poker hands 510, 512, 514 of that previous poker gaming event. Note that in other embodiments, if a poker hand includes an incrementing subsymbol, the associated next-game multiplier may not be decremented.

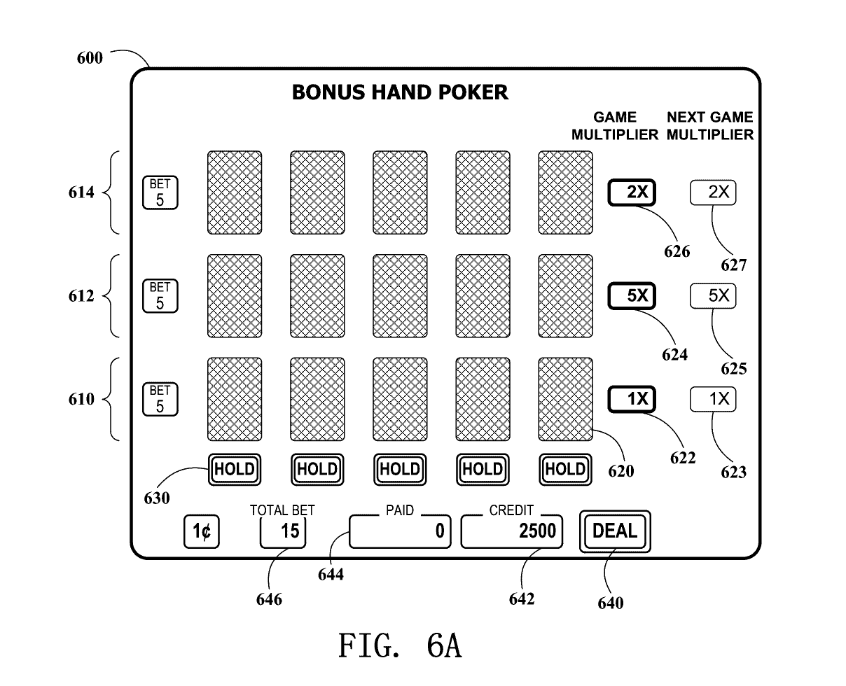

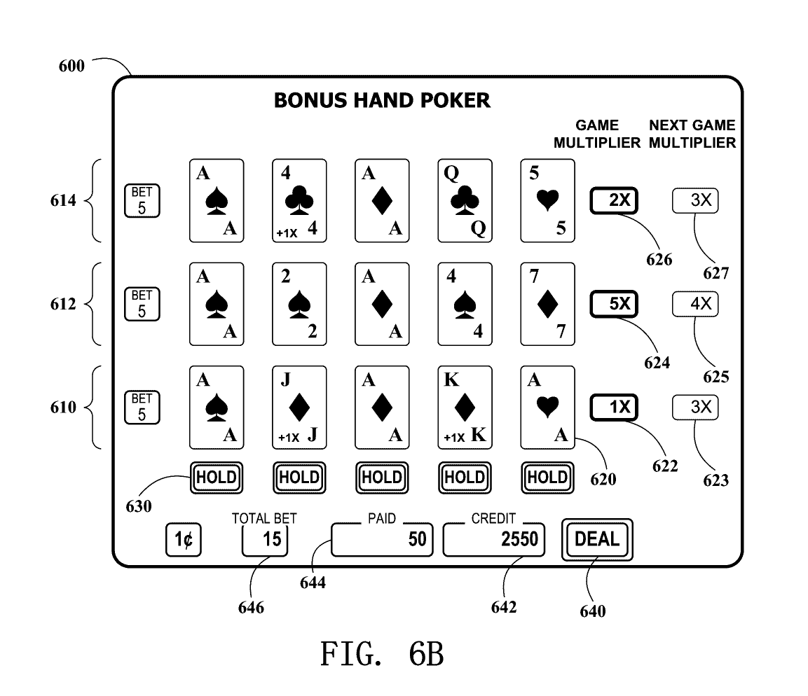

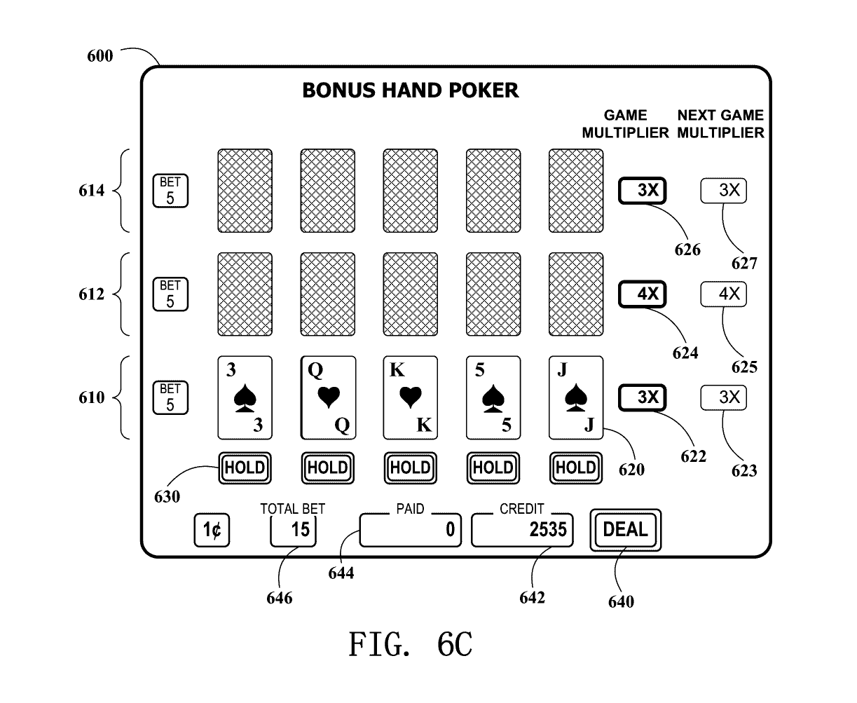

Referring to FIGS. 6A-6C, a game display 600 includes a first grid of card position 610 forming a first poker hand when cards 620 are dealt to the card positions, a second grid of card position 612 forming a first poker hand when cards 620 are dealt to the card positions, a third grid of card position 614 forming a first poker hand when cards 620 are dealt to the card positions, and a player interface portion having a one or more interactive buttons (such as hold buttons 630 and a deal/draw button 640), a credit meter 642, and paid meter 644, and a total bet meter 646. In addition the display includes a first current-game multiplier meter 622, a first next-game multiplier meter 623, a second current-game multiplier meter 624, a second next-game multiplier meter 625, a third current-game multiplier meter 626, and a third next-game multiplier meter 627 respectively associated with the first, second, and third grids of card positions 610, 612, 614.

As shown in FIGS. 6A-6C, a similar game progression as shown in FIGS. 5A-5C can be carried out using the two separate meters for each poker hand 610, 612, 614. Here, the current-game multiplier meters 622, 624, and 626 show multipliers used for a current hand, and the next-game multipliers 623, 625, 627 show the multipliers that will be available for the next played poker gaming event. When the next poker gaming event is wagered on, the values in the next-game multiplier meters 623, 625, 627 will transfer over or be copied to the respective current-game multiplier meters 622, 624, 626. The next-game multiplier meters 623, 625, 627 may initially show the same values as the current-game multiplier meters 622, 624, 626, but may be modified during game play by being incremented upon receipt of incrementing subsymbols, or decremented if no incrementing subsymbols are present.

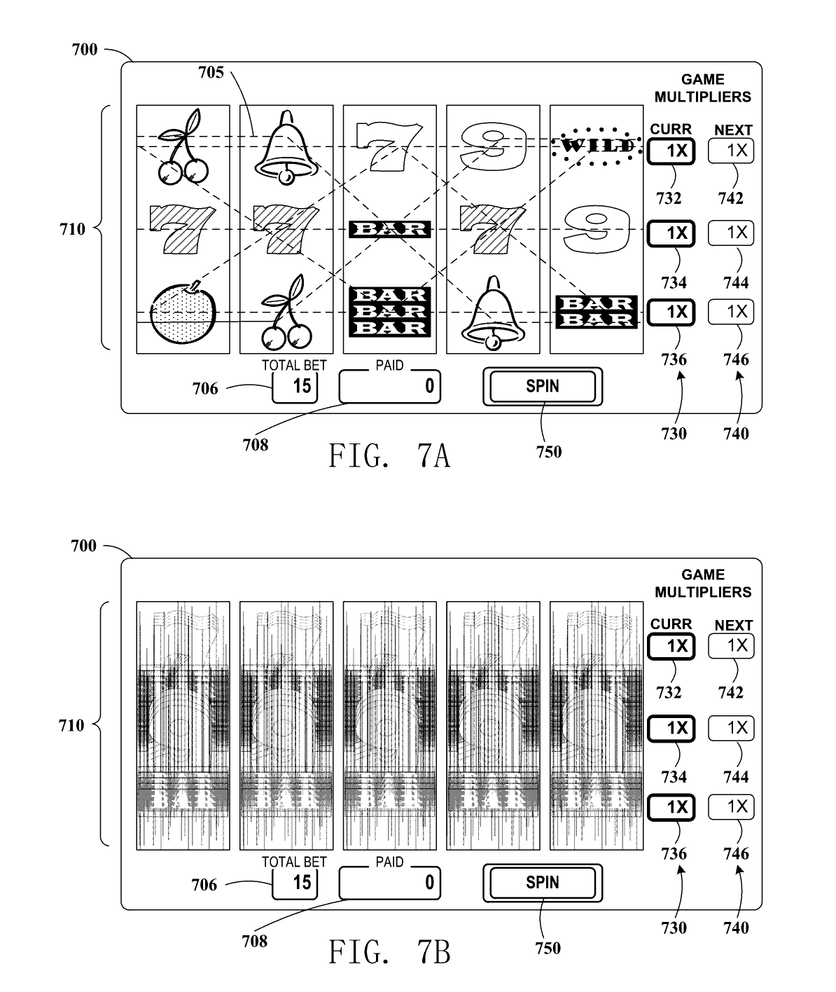

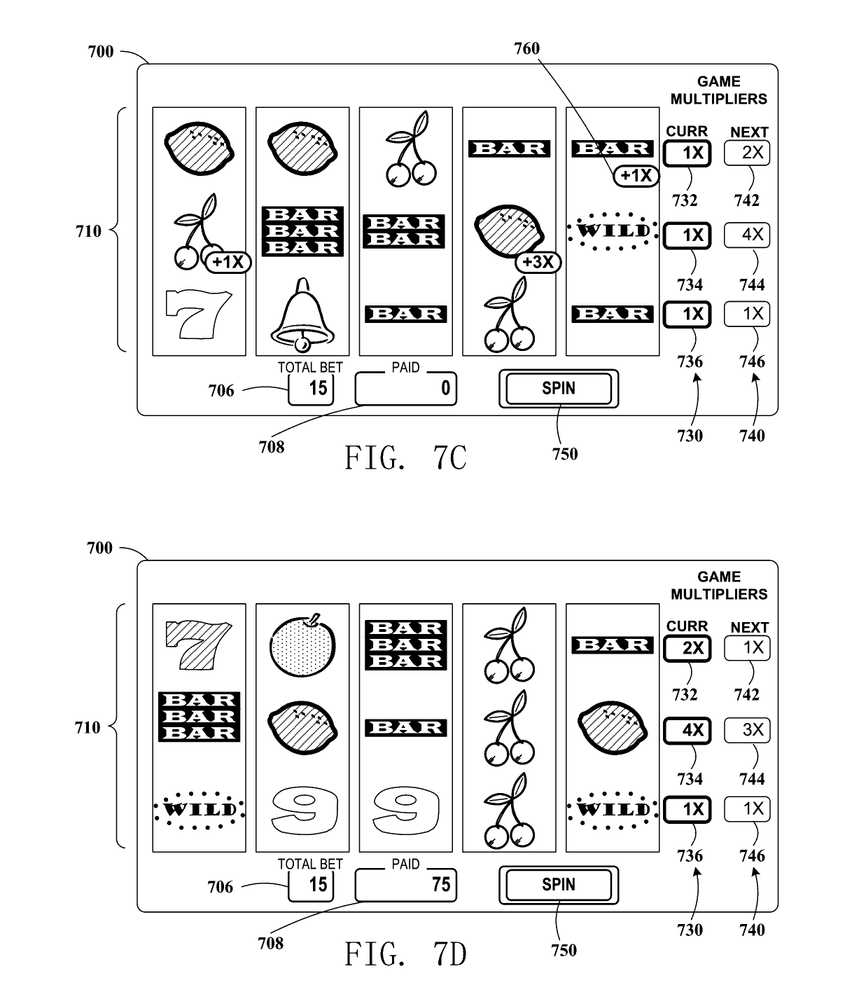

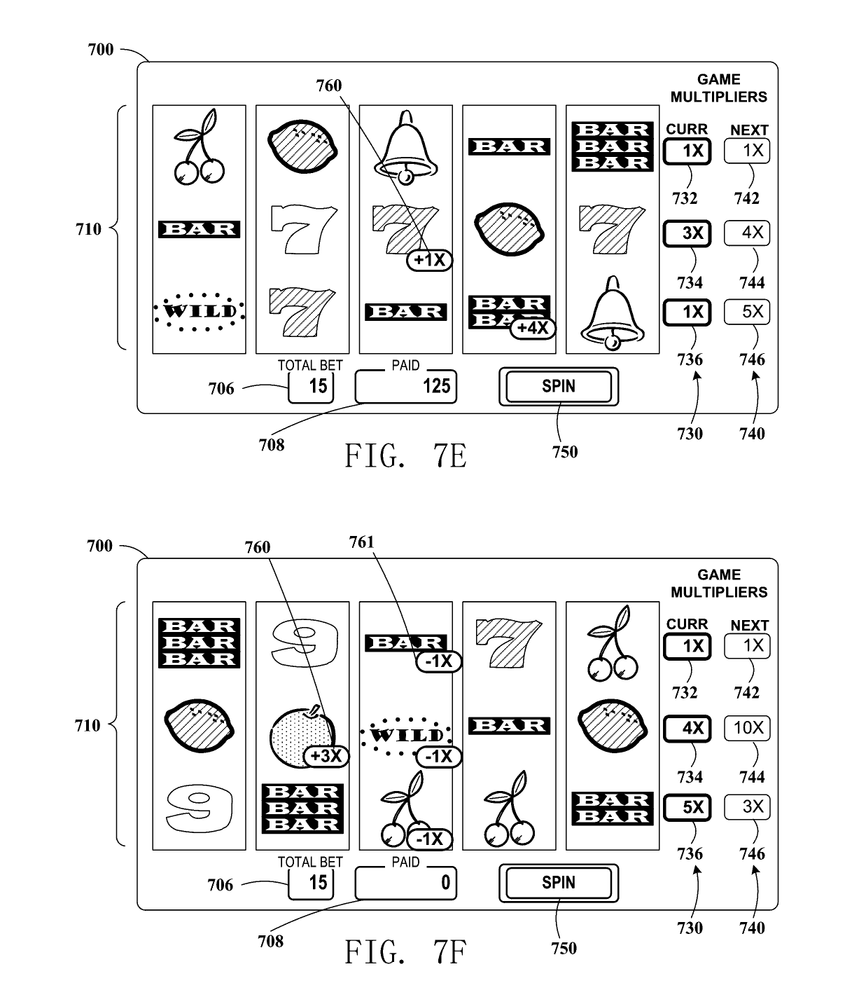

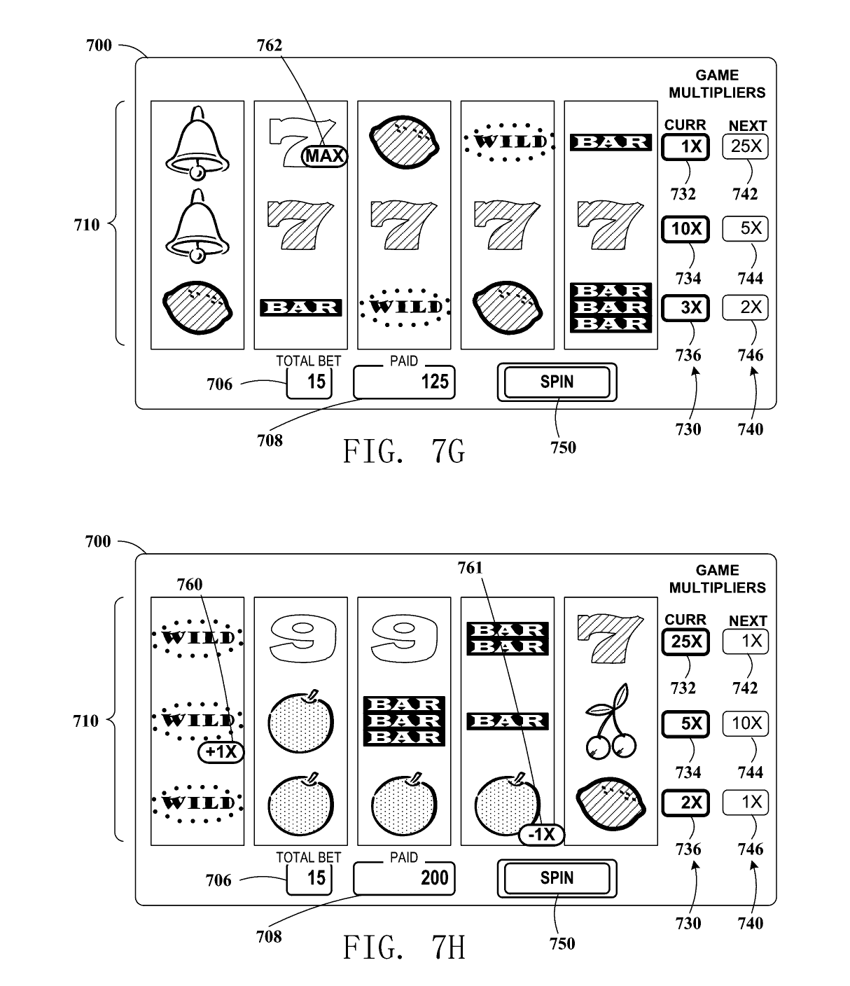

FIGS. 7A-7H are diagrams of a gaming display showing another progression of gaming events using a current-game multiplier (or game multiplier) and a next-game multiplier for each row of the game grid 710. Referring to FIGS. 7A-7H, a gaming display 700 includes a player interface portion having a Total Bet Meter 706, a Paid Meter 708, and a SPIN button 750. The gaming display 700 also includes a game grid 710 showing portions of five game reels each having multiple game symbols, and a plurality of paylines 705 that are associated with patterns of game elements in the game grid 710. Note that the plurality of paylines may take the form of many patterns, and may include many more paylines than are shown in FIG. 7A. The game display 700 also shows game multiplier meters that are associated with each row of the game grid 700. These multiplier meters include current-game multipliers 730 and next-game multiplier meters 740. As there are three rows (and unimportantly, for this embodiment, five columns) of game element positions in the game grid 710, there are three current-game multipliers 730 (732 for the top row, 734 for the middle row, and 736 for the bottom row) and there are three nest-game multipliers 740 (742 for the top row, 744 for the middle row, and 746 for the bottom row).

In this embodiment, each payline that ends at a particular row (i.e., the last game element included in the game element pattern defining the payline) is assigned to the particular row, and hence is associated with the current-game multiplier 730 and next-game multiplier 740 of that row. In other embodiments, the game multipliers may be associated with rows and the paylines may be assigned to the rows based on which row the payline begins in. In other embodiments, the paylines themselves may be irrelevant to the row multipliers and any pay that ends, begins, or touches a row may be multiplied by an associated current-game multiplier 730. Although multiple game multipliers are associated with rows in this embodiment, in other embodiments multiple game multipliers may associated with columns (such as where a pay combo ends), associated with different pay categories (line pays, scatter pays, bonus pays, wild pays, mystery pays, etc.), or be associated with other different characteristics of the game layout, game grid, game rules, or game play.

Referring to FIG. 7B, the reels in the game grid 710 are spun. In FIG. 7C, the reels stop and are evaluated for awards. Here, and awards determined from the evaluation of the game outcome are multiplied by the associated current-game multiplier. In addition, any overlay incrementing subsymbols 760 that appear in a row are used to increment (or decrement) the next-game multiplier 740 associated with that row. As shown in FIG. 7C, the top and middle rows include incrementing subsymbol overlays 760 that increment the respective top and middle next-game multipliers 742, 744.

The next game is shown in FIG. 7D, where the values of the next-game multipliers in the previous game shown in FIG. 7C are copied to the current-game multiplier values. In FIG. 7E, more incrementing subsymbols 760 are received, thereby modifying the associated next-game multipliers. In FIG. 7F, a decrementing subsymbol 761 overlay is received in all of the rows, which decrements the next-game multipliers in the associated rows of the game grid 710 (although not below the value of one, as shown in the top row). In FIG. 7G, a “Max” incrementing subsymbol 762 is received in the top row, thereby making the next-game multiplier for the top row 742 go to a maximum predefined multiplier value (here 25×). In FIG. 7H, the incrementing 760 and decrementing 761 subsymbol overlays are received.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a player input apparatus;
a game display configured to display a game grid of game elements, the game grid including a plurality of rows and plurality of columns, where each row of the game grid is associated with a current-game multiplier and associated with a next-game multiplier;
a memory configured to store a credit amount and a plurality of paylines, where each payline is associated with a pattern of game elements in the game grid, and where each payline is assigned an association with at least one of the plurality of rows of the game grid;
a wager input device structured to receive a physical item associated with a currency value;
a processor configured to:
receive a signal from the wager input device that a physical item associated with a currency value has been received;
increase the credit amount stored in the memory based on the currency value of the received physical item;
receive signals transmitted from the player input device to place a first wager on a first gaming event, the first wager deducted from the credit amount stored in the memory;
determine an outcome for the first gaming event;
display the determined outcome for the first gaming event on the game grid by displaying symbols in each of the game elements in the game grid;
evaluate the plurality of paylines for symbol combinations associated with awards;
for each payline associated with an award, multiply the award associated with the payline by the current-game multiplier of the row that has the assigned association for that payline to determine a final award;
for each row of the plurality of rows in the game grid:
determine if an incrementing condition is satisfied,
determine the next-game multiplier associated with the row by incrementing the current-game multiplier associated with the row when an incrementing condition is satisfied, and
determine the next-game multiplier associated with the row by decrementing the current-game multiplier associated with the row when an incrementing condition is not satisfied; and
provide the determined final awards for the first gaming event, where the awards increase the credit amount stored in the memory.

2. The gaming device of claim 1, wherein each payline is assigned an association with at least one of the plurality of rows based on a row where the payline begins.

3. The gaming device of claim 1, wherein each payline is assigned an association with at least one of the plurality of rows based on a row where the payline ends.

4. The gaming device of claim 1, wherein an incrementing condition is satisfied for a row when a predetermined symbol appears in a game element of that row.

5. The gaming device of claim 1, wherein an incrementing condition is satisfied for a row when a subsymbol appears in a game element of that row.

6. The gaming device of claim 5, wherein each subsymbol is associated with a value.

7. The gaming device of claim 6, wherein the next-game multiplier associated with the row is determined by incrementing the current-game multiplier based on the values of the subsymbols appearing in that row.

8. The gaming device of claim 1, wherein determining the next-game multiplier associated with the row by decrementing the current-game multiplier associated with the row includes:
subtracting a value of one from the current-game multiplier associated with the row if the current-game multiplier associated with the row is greater than a value of one; and
setting the next-game multiplier to a value of one if the current-game multiplier associated with the row is equal to a value of one.

9. The gaming device of claim 1, wherein the processor is further configured to:
receive signals transmitted from the player input device to place a second wager on a second gaming event, the second wager deducted from the credit amount stored in the memory;
identify each of the current-game multipliers associated with each of the respective rows by copying the plurality of next-game multipliers determined in the first gaming event to the respective ones of the plurality of current-game multipliers for the second gaming event;
determine an outcome for the second gaming event;
display the determined outcome for the second gaming event on the game grid by displaying symbols in each of the game elements in the game grid;
evaluate the plurality of paylines for symbol combinations associated with awards;
for each payline associated with an award, multiply the award associated with the payline by the current-game multiplier of the row that has the assigned association for that payline to determine a final award;
for each row of the plurality of rows in the game grid:
determine if an incrementing condition is satisfied,
determine the next-game multiplier associated with the row by incrementing the current-game multiplier associated with the row when an incrementing condition is satisfied, and
determine the next-game multiplier associated with the row by decrementing the current-game multiplier associated with the row when an incrementing condition is not satisfied; and
provide the determined final awards for the second gaming event, where the awards increase the credit amount stored in the memory.

10. A gaming device comprising:
a player input apparatus;
a game display configured to display a game grid of game elements and a game multiplier;
a memory configured to store a credit amount;
a wager input device structured to receive a physical item associated with a currency value;
a processor configured to:
receive a signal from the wager input device that a physical item associated with a currency value has been received;
increase the credit amount stored in the memory based on the currency value of the received physical item;
receive signals transmitted from the player input device to place a first wager on a first gaming event, the first wager deducted from the credit amount stored in the memory;
determine an outcome for the first gaming event;
display the determined outcome for the first gaming event on the game grid by displaying symbols in each of the game elements in the game grid;
evaluate the game grid for symbol combinations associated with awards;
multiply any awards associated the outcome of the first gaming event by the game multiplier to determine a final award;
determine if an incrementing condition is satisfied;
determine a next-game multiplier by incrementing the game multiplier when an incrementing condition is satisfied;
determine the next-game multiplier by decrementing the game multiplier associated with the row when an incrementing condition is not satisfied; and
provide the determined final award for the first gaming event, where the awards increase the credit amount stored in the memory.

11. The gaming device of claim 10, wherein an incrementing condition is satisfied when a predetermined symbol appears in at least one game element of the game grid.

12. The gaming device of claim 10, wherein an incrementing condition is satisfied when a subsymbol appears in at least one game element of the game grid.

13. The gaming device of claim 12, wherein each subsymbol is associated with a value.

14. The gaming device of claim 13, wherein the next-game multiplier is determined by incrementing the game multiplier based on the values of the subsymbols appearing in the game grid.

15. The gaming device of claim 10, wherein determining the next-game multiplier by decrementing the current-game multiplier associated with the row includes:
subtracting a value of one from the current-game multiplier associated with the row if the current-game multiplier associated with the row is greater than a value of one; and
setting the next-game multiplier to a value of one if the current-game multiplier associated with the row is equal to a value of one.

16. The gaming device of claim 10, wherein both the game multiplier and next-game multiplier are shown on the display.

17. The gaming device of claim 10, wherein the processor is further configured to:
receive signals transmitted from the player input device to place a second wager on a second gaming event, the second wager deducted from the credit amount stored in the memory;
identify the game multiplier for the second gaming event by setting the game multiplier to the next-game multiplier determined in the first gaming event;
determine an outcome for the second gaming event;
display the determined outcome for the second gaming event on the game grid by displaying symbols in each of the game elements in the game grid;
evaluate the game grid for symbol combinations associated with awards;
multiply any awards associated the outcome of the second gaming event by the game multiplier to determine a final award;
determine if an incrementing condition is satisfied;
determine a next-game multiplier by incrementing the game multiplier when an incrementing condition is satisfied;
determine the next-game multiplier by decrementing the game multiplier associated with the row when an incrementing condition is not satisfied; and
provide the determined final award for the second gaming event, where the awards increase the credit amount stored in the memory.

18. A method of operating a gaming device including a player input apparatus, a game display configured to display a game grid of game elements and a game multiplier, a memory configured to store a credit amount, a wager input device structured to receive a physical item associated with a currency value, and a processor, the method comprising:
receiving a signal from the wager input device that a physical item associated with a currency value has been received;
increasing the credit amount stored in the memory based on the currency value of the received physical item;
receiving signals transmitted from the player input device to place a first wager on a first gaming event, the first wager deducted from the credit amount stored in the memory;
determining an outcome for the first gaming event;
displaying the determined outcome for the first gaming event on the game grid by displaying symbols in each of the game elements in the game grid;
evaluating the game grid for symbol combinations associated with awards;
multiplying any awards associated the outcome of the first gaming event by the game multiplier to determine a final award;
determining if an incrementing condition is satisfied;
determining a next-game multiplier by incrementing the game multiplier when an incrementing condition is satisfied;
determining the next-game multiplier by decrementing the game multiplier associated with the row when an incrementing condition is not satisfied; and
providing the determined final award for the first gaming event, where the awards increase the credit amount stored in the memory.

19. The method of claim 18, wherein an incrementing condition is satisfied based on a predefined threshold being met for a random event.

20. The method of claim 18, wherein a side wager is required on a gaming event to be eligible for the game multiplier.
